(19) United States
(12) Patent Application Publication
(10) Pub. No.: US 2003/0221119 A1
(43) Pub. Date: Nov. 27, 2003

(54) Methods and apparatus for communicating with a security access control system

(76) Inventors: Richard Gustav Geiger, Delray Beach, FL (US); James Kenneth Krieg, Boynton Beach, FL (US); Theophilos Antoniou, Plantation, FL (US); Jeffrey Scott Snyder, Parkland, FL (US); Tim McClure, Lake Worth, FL (US); Noah Paul Orlen, Boca Raton, FL (US); Paul Edward Goodner, Lake Worth, FL (US); Michael Paul Kobela, Boca Raton, FL (US)

Correspondence Address: John S. Beulick, Armstrong Teasdale LLP, Suite 2600, One Metropolitan Sq., St. Louis, MO, 63102, US

(21) Appl. No.: 10/153,758

(22) Filed: May 21, 2002

(51) Int. Cl. G06F 11/30

(52) U.S. Cl. 713/200

(57) ABSTRACT

Methods and apparatus for communicating with a security access control system are provided. The method includes receiving a definition for an access control event, receiving data from the access control system, and providing an indication when the received data satisfies the received definition.

### BACKGROUND OF THE INVENTION

This invention relates to systems having statuses, events and capable of generating messages relating to these status and events, either spontaneously or in response to external queries, and in some cases capable of responding to external messages to cause a change in status or to generate further events, or cause devices in communication with the system or controlled by the system to switch, change value or change status. The statuses may be one or more enumerated states or continuous ranges of values.

One application for such systems relates to security access control systems, and more particularly to methods and apparatus for communicating with a security access control system.

With the proliferation of automated (i.e., computerized) systems for intrusion detection and sensor monitoring, a number of challenges have arisen in the lack of ability for these systems to interact and/or knowledge of the state, status, or occurrence of events be combined to create enhanced information for persons concerned with the management and or security of a facility outfitted with such systems.

One example is the recent introduction of less costly video capture devices and less costly digital storage devices (e.g., hard drives), video surveillance has increased steadily and a number of challenges have arisen. In particular, at least some known security access control systems do not allow for interconnection of more than one or a very few such digital video devices except by specific tightly bound construction that is lengthy and expensive and does not permit a high level of customization.

### BRIEF DESCRIPTION OF THE INVENTION

In one aspect, a method for communicating with a security access control system is provided. The method includes receiving a definition for an access control event, receiving data from the access control system, and providing an indication when the received data satisfies the received definition.

In another aspect, a computer for communicating with a security access control system is provided. The computer is programmed to receive a definition for an access control event, receive data from the access control system, and provide an indication when the received data satisfies the received definition.

In a further aspect, a computer readable medium is encoded with a computer program. The program is configured to instruct a computer to receive a definition for an access control event, receive data from the access control system, and provide an indication when the received data satisfies the received definition.

### BRIEF DESCRIPTION OF THE DRAWINGS

FIG. 1 illustrates a known security access control system.

FIG. 2 illustrates an integration system.

FIG. 3 illustrates an event mapping interface that allows a user to define an event for the integration system illustrated in FIG. 2.

FIG. 4 illustrates the event mapping interface shown in FIG. 3 when MediaManager is the selected subsystem.

FIG. 5 illustrates the event mapping interface shown in FIG. 3 allowing the user to set a preset for each camera.

FIG. 6 illustrates an imported access points page.

FIG. 7 illustrates a DVMR management interface.

FIG. 8 illustrates a Camera Management interface.

FIG. 9 illustrates a proxy interface for receiving access control system information.

FIG. 10 illustrates an alarm color interface.

FIG. 11 illustrates a workspace interface.

FIG. 12 illustrates a Main Viewer interface.

FIG. 13 illustrates a CCTV interface.

FIG. 14 illustrates the integration system shown in FIG. 2 connected to a plurality of access control systems.

### DETAILED DESCRIPTION OF THE INVENTION

As used herein, an element or step recited in the singular and preceded with the word “a” or “an” should be understood as not excluding plural said elements or steps, unless such exclusion is explicitly recited. Furthermore, references to “one embodiment” of the present invention are not intended to be interpreted as excluding the existence of additional embodiments that also incorporate the recited features.

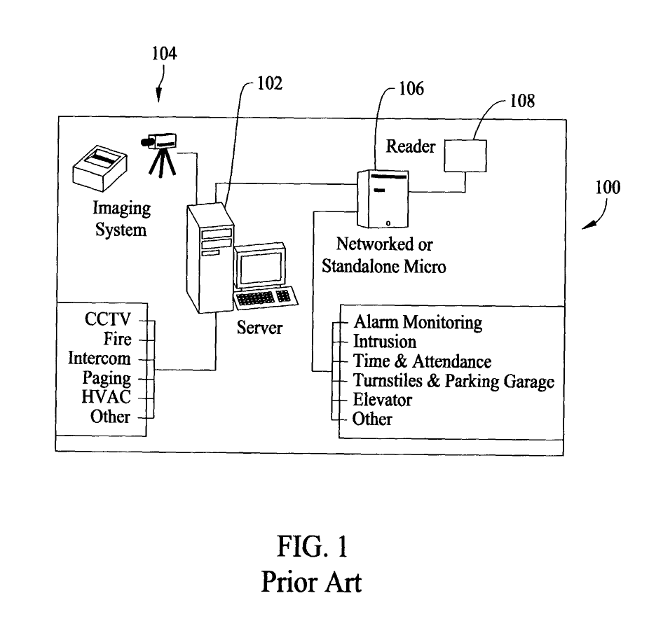

FIG. 1 illustrates a known security access control system 100 such as, for example, a Picture Perfect access control system commercially available from GE Interlogix, Inc. of Austin Tex. System 100 includes a server 102 connected to an imaging system 104 and a microcontroller 106 such as a Micro/5-PXN network microcontroller also commercially available from GE Interlogix. Microcontroller 106 is also connected to at least one reader 108. Typical readers 108 include proximity, Wiegand, smart card, magstripe, long range, and biometric readers. System 100 includes numerous features for monitoring events and other tasks such as Guard Tours. The events include, but are not limited to, window and door alarms, motion detector alarms, fire and smoke alarms, heating/ventilation/air conditioning (HVAC) alarms, closed circuit television (CCTV) data, elevator movement data, and badge system data. In use, system 100 provides for centralized access control. Additionally, a plurality of systems 100 can be networked together to provide a cohesive network solution for enterprises.

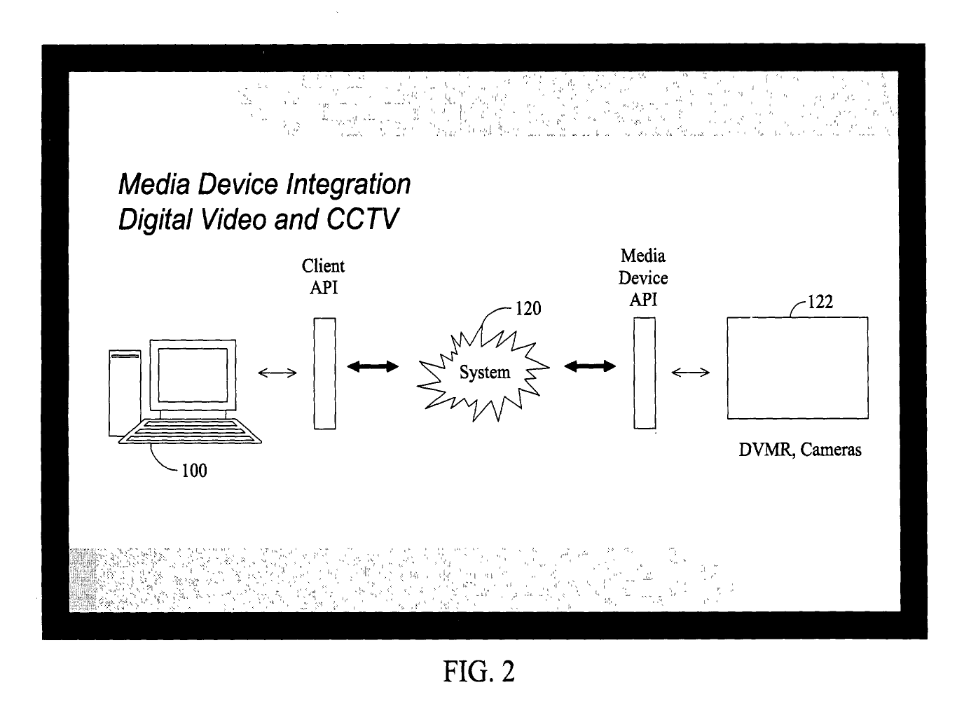

FIG. 2 illustrates an integration system 120 operationally connected to access control system 100 and a media system 122. In the exemplary embodiment, integration system 120 is operationally connected to control system 100 and media system 122 through a plurality of application programming interfaces (API). The APIs are bi-directional and allow for events from access control system 100 and media system 122 to be sent to integration system 120. Additionally, commands and data requests from integration system 120 are sent to access control system 100 and media system 122 via the APIs. In use, integration system 120 receives definitions of events from a user and received data from control system 100 and media system 122, and when the received data satisfies the received definition, integration system 120 provides an indication as described in more detail below. In one embodiment, integration system 120 is a computer 120 programmed to perform functions described herein. It is contemplated that the methods and functions herein described can be implemented with any programmable circuit, and accordingly, as used herein, the term computer is not limited to just those integrated circuits referred to in the art as computers, but broadly refers to computers, processors, microcontrollers, microcomputers, programmable logic controllers, application specific integrated circuits, and other programmable circuits.

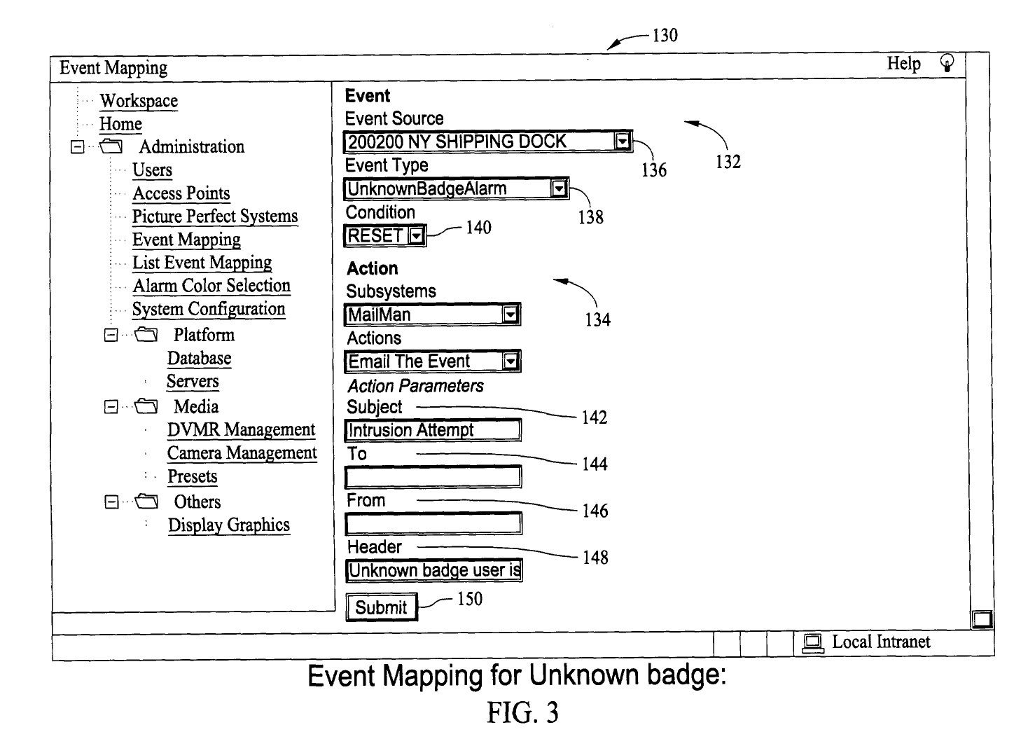

FIG. 3 illustrates an exemplary embodiment event mapping interface 130 that allows a user to define an event for integration system 120 (shown in FIG. 2). Interface 130 includes an event section 132 and an action section 134. Event section 132 includes an event source field 136, an event type field 138, and a condition field 140. In other embodiments, event section 132 includes fields other than source field 136, event type field 138, and condition field 140. The user defines an event by entering an event source, an event type, and/or a condition. In an exemplary embodiment, fields 136, 138, and 140 are pull down menus to facilitate an easy and quick defining of an event. In alternative embodiments, data entry fields other than drop down or pull down menus are provided.

The user also defines an action that system 120 performs upon receiving data corresponding to the defined event occurring. More specifically, integration system 120 receives data from access system 100 and from media system 122 (shown in FIG. 2), and when the received data satisfies the defined event then system 120 provides an indication of the defined event's occurrence. System 120, through interface 130 and, more specifically, through action section 132, allows the user to specify exactly what type of indication system 120 provides. For example, the user can specify that an email be sent to a specified address and/or that a camera be turned to record a certain area. The user can also specify that camera data be saved and/or emailed. For example, media system 122 typically includes a plurality of digital cameras and digital video multilplexer and recorders (DVMRs). Each DVMR receives video data from a plurality of cameras and multiplexes the data, and also records the multiplexed data in a rewriteable storage unit such as a hard drive.

The rewriteable storage unit is written to until full and then data is rewritten as it is received. Therefore, the storage unit has a finite capacity and only maintains a certain time amount of video data. When an event occurs and the user has specified that video data be saved, then the video data regarding that event is maintained even if the original data is overwritten on the rewriteable storage unit. In an exemplary embodiment, system 120 commands system 122 to save the video data and indicates to the user that the video is available and easily accessible. Additionally, the user can specify a time frame for the saved data. For example, the user can specify an amount of time both preceding an event occurrence and an amount of time subsequent the event occurrence (e.g., from 30 seconds prior to the event to 2 minutes after the event) for saving or emailing. Additionally, an event is not limited to just those events signaled by data from access control system 100. Rather, the video data itself can form an event. For example, by comparing pixels frame by frame, motion can be detected. Also, a lack of a video signal from a video camera is an event.

The Storage Unit can be storage medium adapted to provide digital output signals. In one embodiment a rewriteable storage unit is written to until full and then data is rewritten as it is received. Therefore, the storage unit has a finite capacity and only maintains a certain time amount of video data. In another embodiment, the rewriteable digital storage medium records video upon command from system 120. Lastly, larger storage units may present unrestricted capacity including memory storage services available through a memory storage hosting services (e.g., EMC²). This embodiment may also include the ability to transfer stored data to other rewriteable storage units when it becomes full thereby removing the limitation of a fixed amount of storage. Additionally, when utilizing a plurality of storage units to provide unlimited storage amount, and, in one embodiment, the digital storage unit uses non-rewriteable medium.

Additionally, the video data can be compared to data in a database such as a face recognition database, and then a recognition of a face is an event. Therefore, as used herein the term “access control event” refers not just to those events known in the art as access control events but broadly refers to access control events, intrusion events, fire events, and events discernable from video including events discernable solely from video data (i.e., motion) and events discernable from video data in combination with a database (i.e., recognition of a face or other object). Also, access control events includes the status of a sensor including enumerated statuses (i.e., a set of one or more statuses that can be individually counted), and value statuses (i.e., where the value may be in a continuous range rather than one of a specific list of items), command messages, and responses to control messages or inquiry messages. Additionally, as used herein the term “security access system” refers to both those systems known in the art as security access systems (e.g., a Picture Perfect system) including intrusion systems and fire systems, and media system such as media system 122 (shown in FIG. 2).

It is contemplated that the benefits of the invention accrue to all media systems including audio media systems and that an event can be based on sound and voice reorganization, and therefore, the term “access control event” also refers to acoustical events such as, for example, but not limited to, a sound being detected above a certain decibel level and a recognition in an acquired sound sample of a predetermined sound pattern such as is used in glass break detection, speech and/or voice recognition.

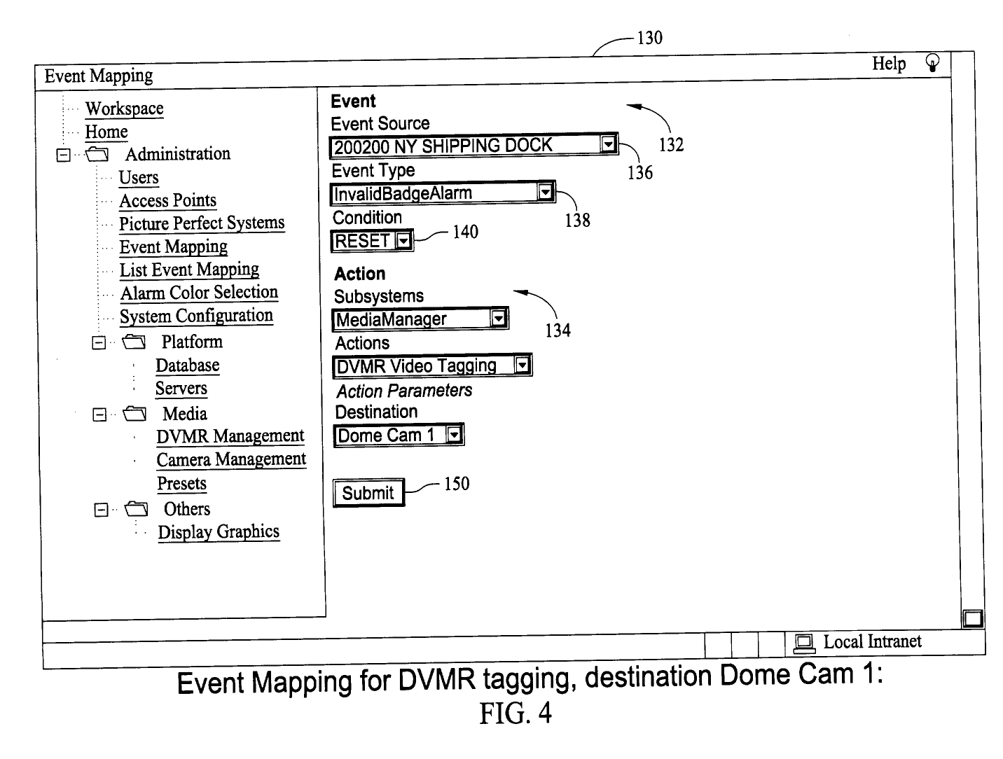

Referring still to FIG. 3, when the user selects email as the action to be taken, the user is also able to enter action parameters such as a subject line, a to email address, a from email address, and a message header. The action parameters available depend upon which action is selected. More particularly, the user selects a subsystem such as a MailMan subsystem and a MediaManager subsystem. Once a subsystem is selected then the actions performable by the selected subsystem are displayed. FIG. 4 illustrates event mapping interface 130 when MediaManager is the selected subsystem, and one action option is DVMR Video Tagging for tagging video relating to the event for saving the video and/or emailing the video.

The user also can select the video source for the tagging. For example, as illustrated in FIG. 4, Dome Camera 1 is selected as the source. When the user is finished defining an event and associating (i.e., mapping) an action to the defined event, the user selects a submit button 150 to initiate system 120 to scan data received from security access control system 100 and media system 122 for data that satisfies the submitted definition. Through repeated use of interface 130, a plurality of actions can be mapped for a single defined event and a plurality of actions can be mapped for a plurality of defined events. Accordingly, system 120 provides for a high level of user customization for different configurations of access control systems 100 and media systems 122. Additionally, because, in one embodiment, integration system 120 interfaces with access control system 100 and media system 122 through APIs, different access control systems and media systems including proprietary and non-proprietary systems are all interfaceable with a single integration system 120 using appropriate drivers specific for each access control system and each media system that map the features and functions of those systems to the API. Also, as new access control systems are developed, integration system 120 does not become obsolete. Rather a new driver is developed for the new access control system and little or no modification to integration system 120 is necessary.

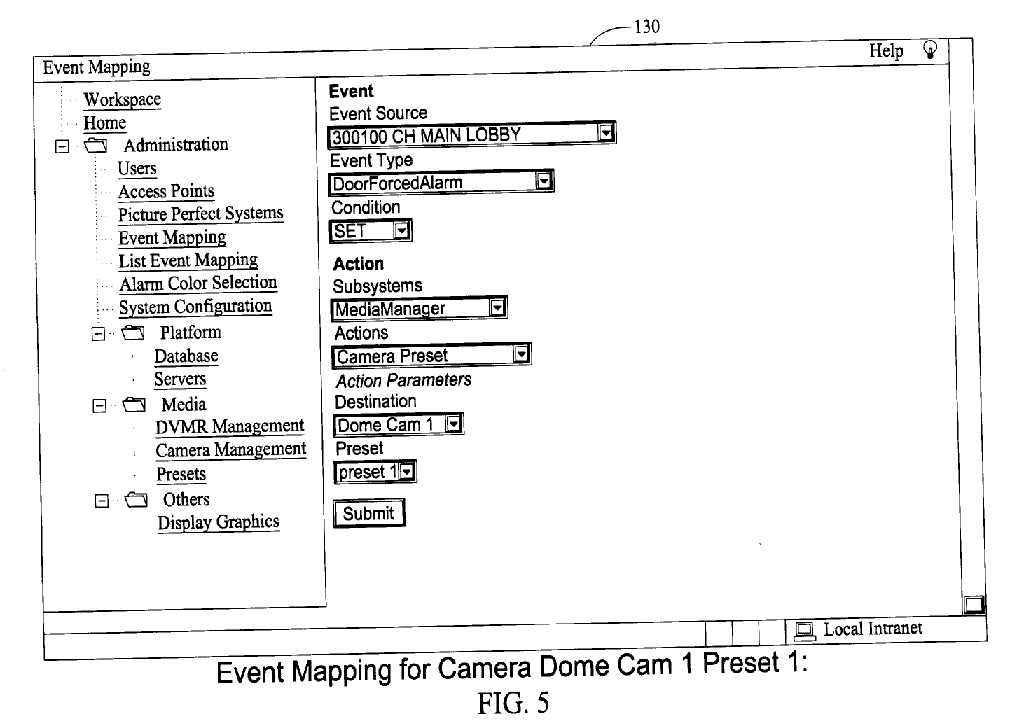

FIG. 5 illustrates event mapping interface 130 also allows the user to set a preset for each camera. The preset is the location that the camera turns to (if not already pointed at the preset location) when the received data satisfies the defined event. Accordingly, a camera can be rotated to cover a large area having several alarm zones and when a specific alarm is triggered, the camera is directed to that zone for the triggered alarm. For example, a camera is directed to pan back and forth between a window and a door. The operator defines one event to be an alarm that the window is open and associates with that event a preset direction for the camera such that the camera is pointed at the window when pointed in the preset direction. Upon system 120 receiving data that satisfies that event (i.e., a window alarm for that particular window) system 120 communicates to the camera to point in the preset direction. The user can also define a second event to be an alarm that the door is open and associate with that event a preset such that the camera points to the door when the camera is in the preset location. Accordingly, a single camera can have a plurality of presets for a plurality of events. Additionally, a plurality of actions can be associated with a single event, and therefore, when the door is opened the camera turns toward the door and video data from before the door was opened and from after the door was opened can be saved and/or emailed.

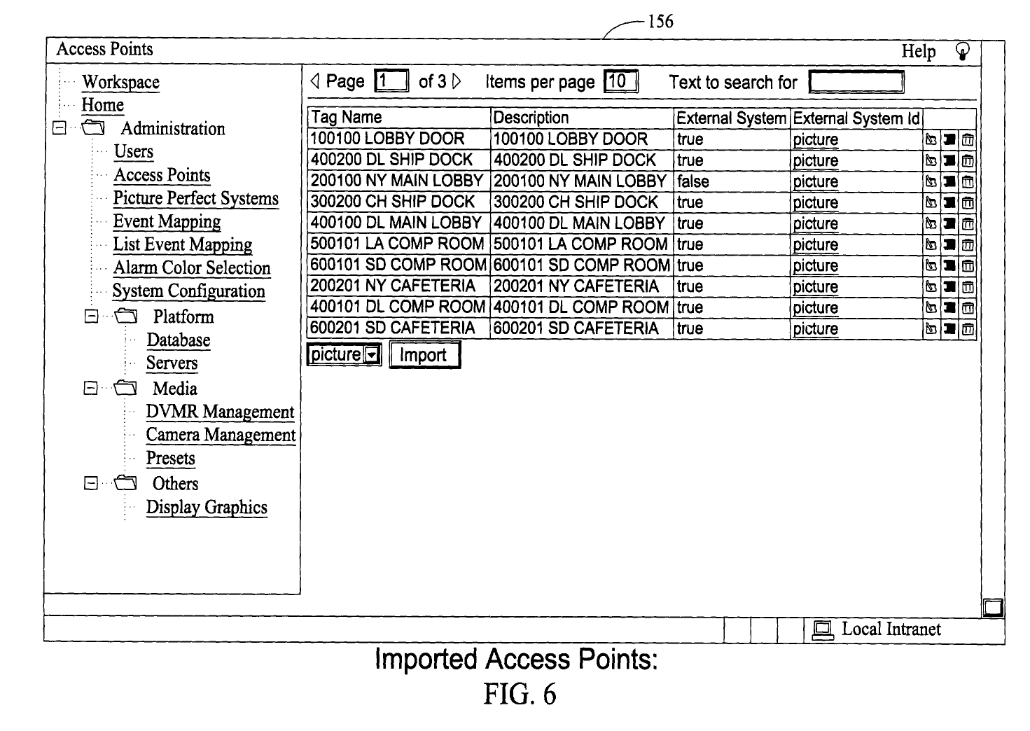

System 120 allows for an importing of access points from access control system 100 and displays the imported access points in an imported access points page 156 as illustrated in FIG. 6. After the access points are imported to system 120, the user can define an event for any access point as detailed above using event mapping interface 130 (shown in FIGS. 3 and 4).

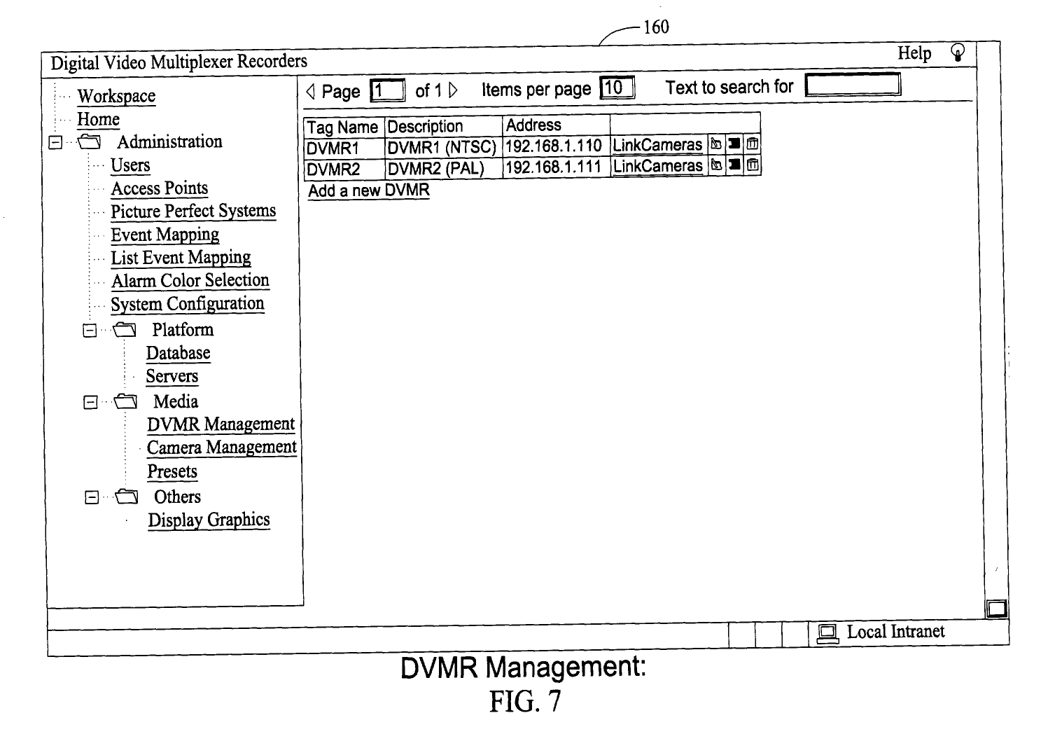

FIG. 7 illustrates a DVMR management interface 160 running on system 120 that allows for assigning tag names, descriptions, Internet Protocol (IP) addresses, and icons for each DVMR device. Additionally, DVMR management interface 160 enables a user to add additional DVMR devices.

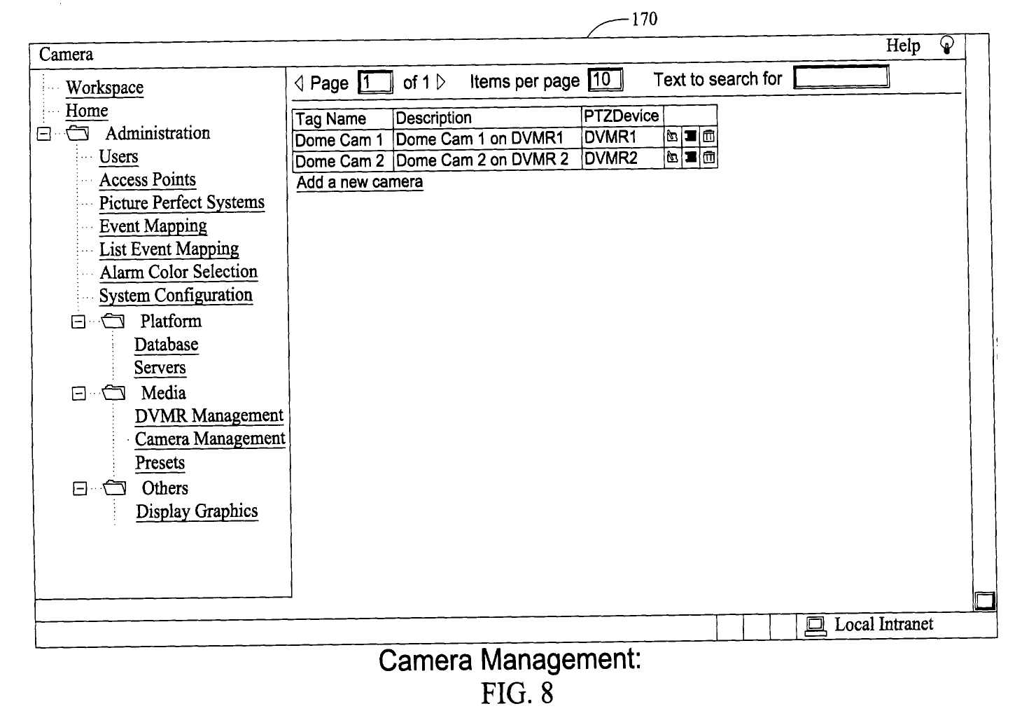

FIG. 8 illustrates a Camera Management interface 170 that enables the user to assign a tag name and a description for a pan tilt zoom (PTZ) video camera. Camera Management interface 170 also allows the user to specify the DVMR associated with each particular camera as well as add additional cameras.

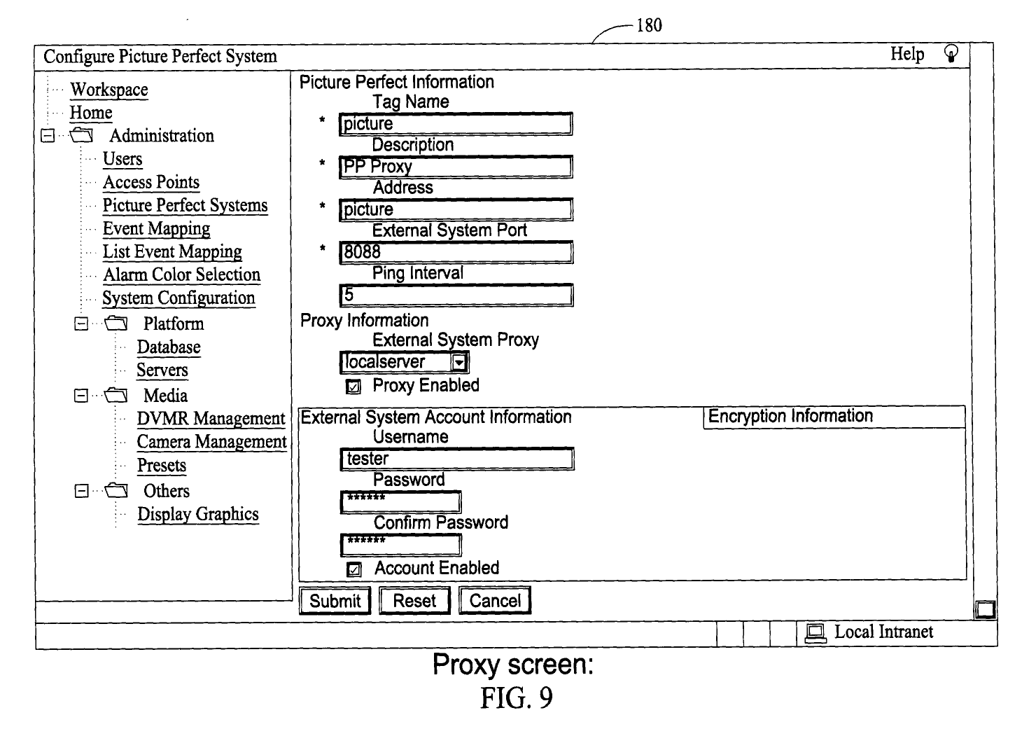

FIG. 9 illustrates a proxy interface 180 for receiving access control system information such as tag names, descriptions, addresses, external system ports, and ping intervals. Proxy interface 180 is also configured to receive proxy information such as a network name for an external system proxy, and a proxy enablement status. Proxy interface 180 also enables a user to enter a username, a password, and an account enabled status. Interface 180 further allows for encrypting information and confirms a user's entered password by prompting the user to enter the password a second time.

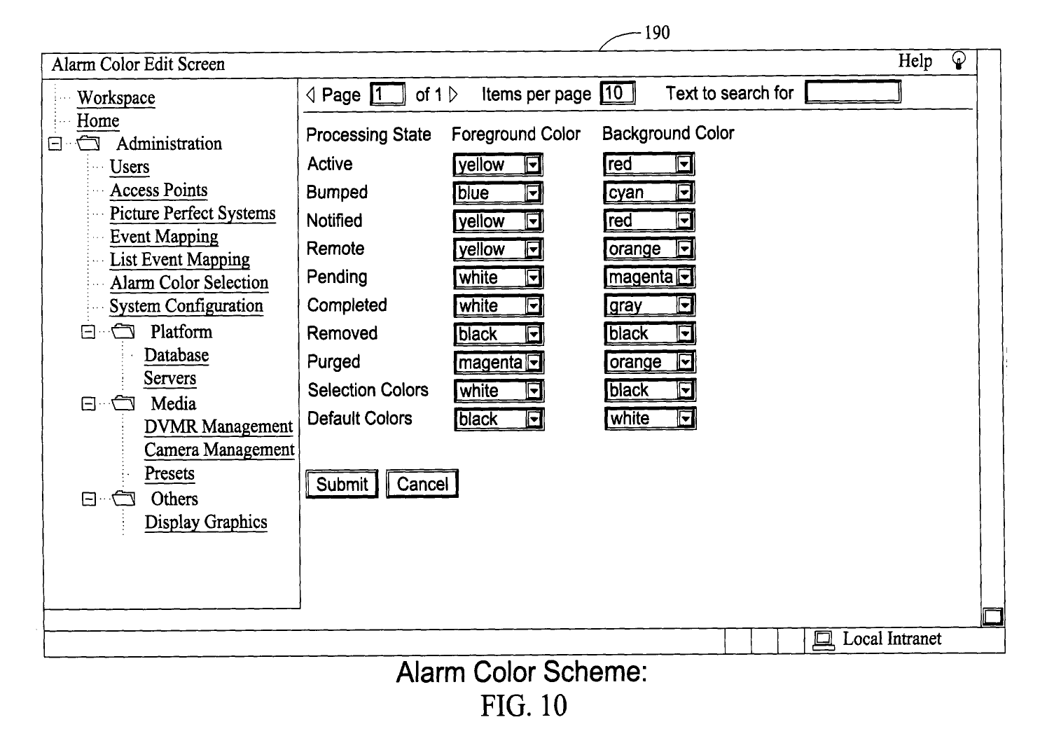

FIG. 10 illustrates an alarm color interface 190 that allows the user to select foreground and background colors for processing states of active, bumped, notified, remote, pending, completed, removed, and purged. Color interface 190 also allows for the selection of selection colors and default colors. Additionally, each of the interfaces illustrated in FIGS. 3-10 allow the user to change interfaces by selecting choices from a tree structure including choices of administration, users, and system configuration including system platform including data base and servers, as well as the interfaces illustrated themselves in FIGS. 3-10.

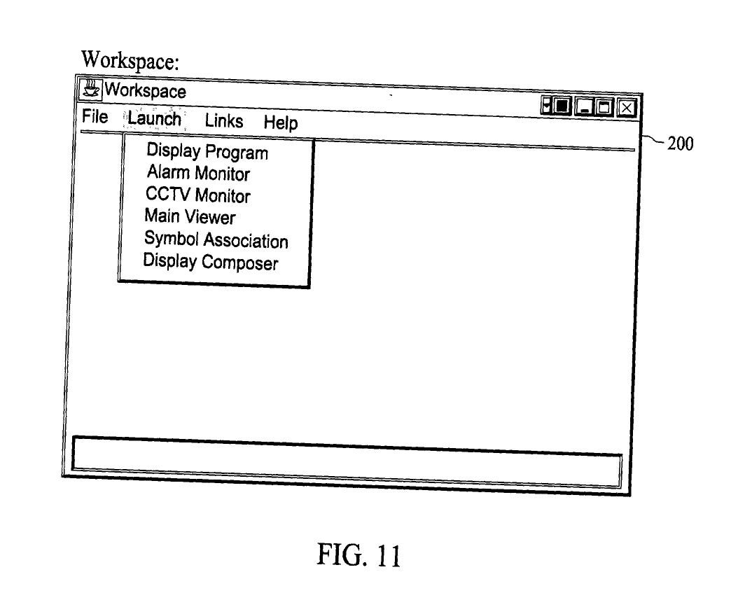

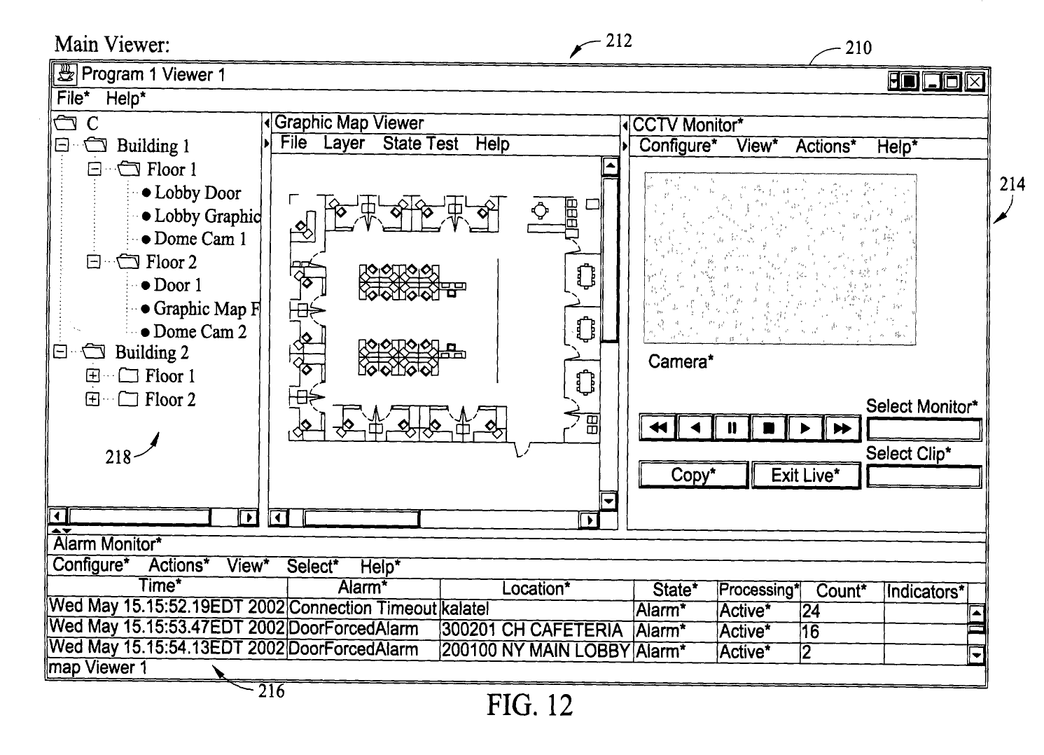

FIG. 11 illustrates a workspace interface 200 that allows the user to select Display Program, Alarm Monitor, CCTV Monitor, Main Viewer, Symbol Association, and Display Composer. FIG. 12 illustrates a Main Viewer interface 210 which is displayed by system 120 when the user selects Main Viewer on workspace interface 200. Main Viewer interface 210 includes a Graphic Map Viewer portion 212, a CCTV monitor 214 portion, and an Alarm Monitor portion 216. Graphic Map Viewer portion 212 displays geographically rooms in a secure environment along with icons representing event locations such as a badge swiping station, doors, windows, and other event locations as are known in the security access control art. Main Viewer interface 210 also includes a tree structure 218 that enables the user to view portions of the secured site not presently displayed in Graphic Map Viewer.

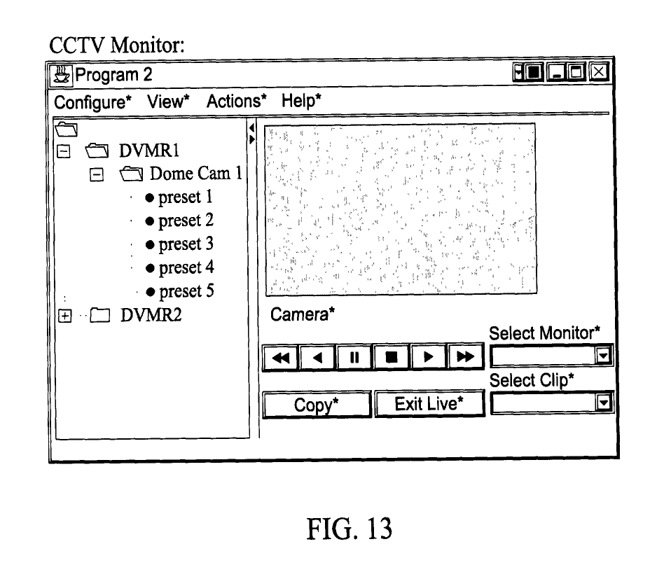

FIG. 13 illustrates a CCTV interface in which the user can select a particular DVMR and all cameras attached to that DVMR. Also for each camera the presets are listed. Once a camera is selected, the user can select which monitor displays the selected camera's video as well as play saved clips from that camera. The saved clips are saved in response to an event happening for which the user has set the action of tagging video for that event.

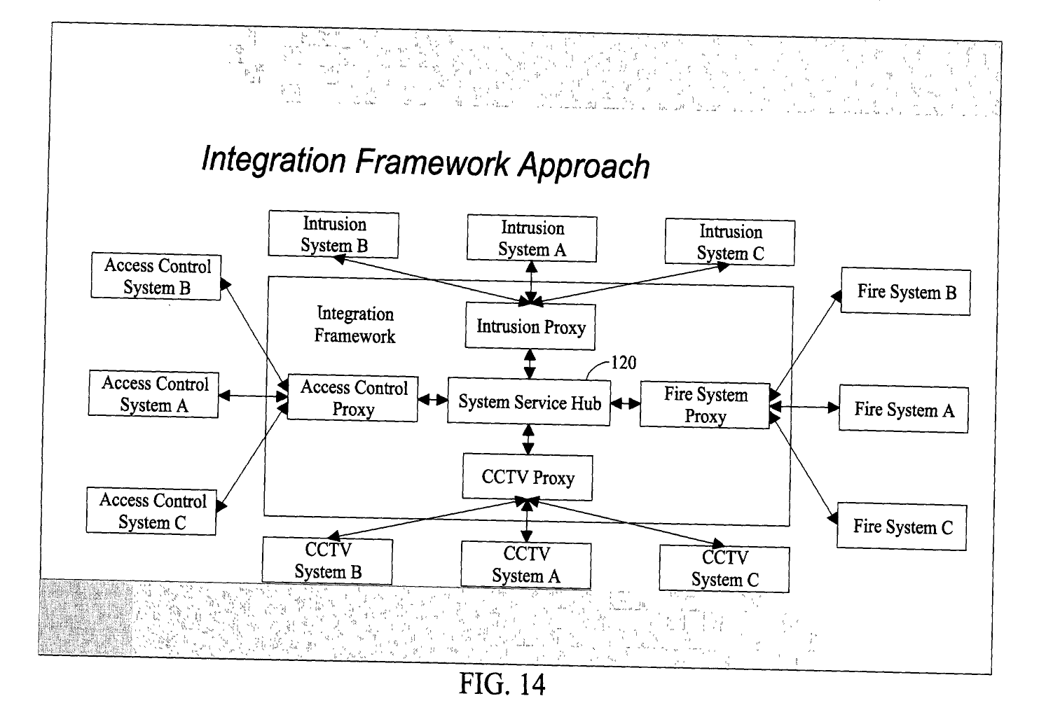

FIG. 14 illustrates integration system 120 (shown in FIG. 2) connected to a plurality of access control systems (as used herein) including access control system (such as access control system 100), intrusion systems, fire systems, and media systems (such as a CCTV system). System 120 interfaces and integrates the plurality of access control systems via a plurality of proxies (e.g., APIs). Once system 120 is connected to an appropriate proxy for a particular system (for example, system 120 is connected to a fire system proxy), a fire system can be added as a plug-n-play device. In other words, system 120 automatically recognizes devices connected to the network and configures the newly connected device without any user input or intervention.

While the invention has been described in terms of various specific embodiments, those skilled in the art will recognize that the invention can be practiced with modification within the spirit and scope of the claims.

What is claimed is:

1. A method for communicating with a security access control system, said method comprising:
receiving a definition for an access control event;
receiving data from the access control system; and
providing an indication when the received data at least partially satisfies the received definition.

2. A method in accordance with claim 1 wherein said providing an indication comprises providing a visual indication when the received data at least partially satisfies the received definition.

3. A method in accordance with claim 2 where said providing a visual indication comprises providing video data when the received data at least partially satisfies the received definition.

4. A method in accordance with claim 3 where said providing video data further comprises providing video data of an event site related to the received definition.

5. A method in accordance with claim 3 where said providing video data further comprises providing video data of an event site related to the received definition including data recorded prior to the provided indication.

6. A method in accordance with claim 1 wherein said receiving a definition comprises receiving a definition for an access control event from a user.

7. A method in accordance with claim 1 further comprising receiving an action for the defined access control event, said providing an indication further comprises providing an indication in accordance with the received action when the received data at least partially satisfies the received definition.

8. A method in accordance with claim 1 wherein said providing an indication comprises providing an indication by sending an email when the received data at least partially satisfies the received definition.

9. A method in accordance with claim 1 wherein said providing an indication comprises providing an indication by saving video data when the received data at least partially satisfies the received definition.

10. A method in accordance with claim 9 wherein said saving video data comprises tagging video data to save such that the tagged video data is from both prior to the receipt of data satisfying the defined event and subsequent to the receipt of data satisfying the defined event when the received data at least partially satisfies the received definition.

11. An indication produced by the method of claim 1.

12. An integration system comprising:
an access control system; and
a computer operationally connected to said access control system, said computer programmed to:
receive a definition for an access control event;
receive data from the access control system; and
provide an indication when the received data at least partially satisfies the received definition.

13. An integration system in accordance with claim 12 wherein said computer further programmed to provide a visual indication when the received data at least partially satisfies the received definition.

14. An integration system in accordance with claim 13 wherein said computer further programmed to provide video data of an event site related to the received definition.

15. An integration system in accordance with claim 14 wherein said computer further programmed to provide video data of an event site related to the received definition including data recorded prior to the provided indication.

16. An integration system in accordance with claim 12 wherein said computer further programmed to receive a definition for an access control event from a user.

17. An integration system in accordance with claim 14 wherein said computer further programmed to:
receive an action for the defined access control event from a user; and
provide an indication in accordance with the received action when the received data at least partially satisfies the received definition.

18. An integration system in accordance with claim 17 wherein said computer further programmed to provide an indication by sending an email when the received data at least partially satisfies the received definition.

19. An integration system in accordance with claim 12 wherein said computer further programmed to provide an indication by saving video data when the received data at least partially satisfies the received definition.

20. An integration system in accordance with claim 14 wherein said computer further programmed to tag video data to save such that the tagged video data is from both prior to the receipt of data satisfying the defined event and subsequent to the receipt of data satisfying the defined event when the received data at least partially satisfies the received definition.

21. An integration system in accordance with claim 12 wherein said computer operationally connected to said access control system via an application programming interface such that said access control system is connectable to said computer with no user input.

22. A computer readable medium encoded with a computer program, said program configured to instruct a computer to:
receive a definition for an access control event;
receive data from the access control system; and
provide an indication when the received data at least partially satisfies the received definition.

23. A computer readable medium in accordance with claim 22 wherein said program further configured to instruct the computer to provide video data of an event site related to the received definition.

24. A computer readable medium in accordance with claim 22 wherein said program further configured to instruct the computer to provide video data of an event site related to the received definition including data recorded prior to the provided indication.

25. A computer readable medium in accordance with claim 22 wherein said program further configured to instruct the computer to receive a definition for an access control event from a user.

26. A computer readable medium in accordance with claim 25 wherein said program further configured to instruct the computer to:
receive an action for the defined access control event from a user; and
provide an indication in accordance with the received action when the received data at least partially satisfies the received definition.

27. A computer readable medium in accordance with claim 22 wherein said program further configured to instruct the computer to provide an indication by sending an email when the received data at least partially satisfies the received definition.

28. A computer readable medium in accordance with claim 22 wherein said program further configured to instruct the computer to provide an indication by saving video data when the received data at least partially satisfies the received definition.

29. A computer readable medium in accordance with claim 28 wherein said program firer configured to instruct the computer to tag video data to save such that the tagged video data is from both prior to the receipt of data at least partially satisfying the defined event and subsequent to the receipt of data at least partially satisfying the defined event when the received data at least partially satisfies the received definition.

30. Apparatus comprising:
means for receiving a definition for an access control event;
means for receiving data from an access control system; and
means for providing an indication when the received data at least partially satisfies the received definition.

31. An apparatus in accordance with claim 30 wherein said means for providing an indication when the received data at least partially satisfies the received definition configured to provide a visual indication when the received data at least partially satisfies the received definition.

32. An apparatus in accordance with claim 31 wherein said means for providing an indication when the received data at least partially satisfies the received definition configured to provide video data of an event site related to the received definition.

33. An apparatus in accordance with claim 32 wherein said means for providing an indication when the received data at least partially satisfies the received definition further configured to provide video data of an event site related to the received definition including data recorded prior to the provided indication.

34. An apparatus in accordance with claim 30 wherein said means for receiving a definition for an access control event configured to receive a definition for an access control event from a user.

35. An apparatus in accordance with claim 32 wherein said means for receiving a definition for an access control event configured to receive an action for the defined access control event from a user, and said means for providing an indication when the received data at least partially satisfies the received definition configured to provide an indication in accordance with the received action when the received data at least partially satisfies the received definition.

36. An apparatus in accordance with claim 35 wherein said means for providing an indication when the received data at least partially satisfies the received definition configured to provide an indication by sending an email when the received data at least partially satisfies the received definition.

37. An apparatus in accordance with claim 30 wherein said means for providing an indication when the received data at least partially satisfies the received definition configured to provide an indication by saving video data when the received data at least partially satisfies the received definition.

38. An apparatus in accordance with claim 32 wherein said means for providing an indication when the received data at least partially satisfies the received definition configured to tag video data to save such that the tagged video data is from both prior to the receipt of data satisfying the defined event and subsequent to the receipt of data satisfying the defined event when the received data at least partially satisfies the received definition.

39. An apparatus in accordance with claim 30 wherein said means for receiving a definition for an access control event comprises a computer.

40. An apparatus in accordance with claim 30 wherein said means for receiving data from the access control system comprises a computer.

41. An apparatus in accordance with claim 30 wherein said means for providing an indication when the received data at least partially satisfies the received definition comprises a computer.

42. An apparatus in accordance with claim 30 wherein said means for receiving a definition for an access control event comprises a computer, said computer comprising said means for receiving data from the access control system and said means for providing an indication when the received data at least partially satisfies the received definition comprise a computer, said computer operationally connected to the access control system via an application programming interface such that the access control system is connectable to said computer with no user input.
